(19) United States
(12) Patent Application Publication
(10) Pub. No.: US 2007/0035382 A1
(43) Pub. Date: Feb. 15, 2007

(54) Radio frequency identification (RFID) device with multiple identifiers and a control input

(76) Inventors: Thomas H. Lee, Burlingame, CA (US); Arthur J. Collmeyer, Incline Village, NV (US); Dickson T. Wong, Burlingame, CA (US)

Correspondence Address: BRINKS HOFER GILSON & LIONE, P.O. BOX 10395, CHICAGO, IL, 60610, US

(21) Appl. No.: 11/498,934

(22) Filed: Aug. 3, 2006

Related U.S. Application Data
(60) Provisional application No. 60/705,311, filed on Aug. 4, 2005.
(60) Provisional application No. 60/705,756, filed on Aug. 5, 2005.

(51) Int. Cl. H04Q 5/22

(52) U.S. Cl. 340/10.1

(57) ABSTRACT

A radio frequency identification (RFID) device with multiple identifiers and a control input is disclosed. In one embodiment, the RFID device comprises a radio frequency (RF) transmitter, a plurality of identifiers, an input operative to receive a selection indicative of a set of the plurality of identifiers, and a control mechanism operative to cause the RF transmitter to transmit the set of identifiers indicated by the selection. The RFID device can comprise a single RFID tag or a plurality of RFID tags, with each RFID tag storing a respective one of the plurality of identifiers.

### CROSS-REFERENCE TO RELATED APPLICATIONS

This application claims the benefit of U.S. Provisional Application No. 60/705,311, filed Aug. 3, 2005, and of U.S. Provisional Application No. 60/705,756, filed Aug. 5, 2005, each of which is hereby incorporated by reference.

### BACKGROUND

Radio Frequency Identification, otherwise known as RFID, has become widely deployed. As the name indicates, RFID is used to electronically record the unique identity of a pallet, parcel, badge, etc. Applications include security access, inventory control, employee identification, and asset management.

The bulk of RFID applications employ passive RFID tags, which do not require a battery. Energy to power the passive RFID tag is provided by an energy transmission element via wireless means. The energy from the energy transmission element is collected by the RFID tag, and the unique ID of the tag is transmitted via radio frequency (RF) transmission. The unique ID is read by an RFID reader, and the unique identification of the tagged object is determined.

Because of the limited range of passive RFID tags, semi-active RFID tags, incorporating a small battery to boost the range of the RF transmitter, have been proposed.

In FIG. 1, RFID tag 50 contains an energy collection element 61, an ID transmitter 52, a unique ID 60 and an optional battery 51. The RFID reader 53 contains an energy transmission element 56 and an ID receiver 57.

Energy from the energy transmission element 56 is sent via wireless transmission means 54 to energy collection element 61. In the absence of optional battery 51, the energy collected is transferred to the ID transmitter 52. The ID transmitter 52 transmits the unique ID 60 to the ID receiver 57. In the presence of optional battery 51, the energy collected by energy collection element 61 is applied to initiate transmission of unique ID 60 to ID receiver 57 utilizing the energy stored in the battery.

With appropriate extension, the use of passive and semi-active RFID tags can be expanded to new applications, as detailed in the following paragraphs.

### BRIEF DESCRIPTION OF THE DRAWINGS

FIG. 1 is an illustration of a prior art RFID tag.

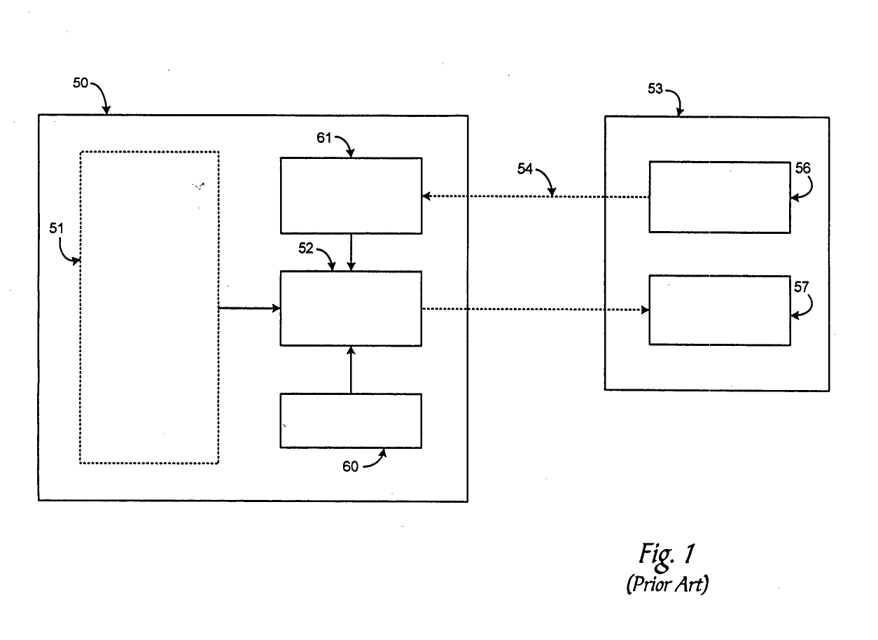

FIG. 2 is an illustration of a multi-ID tag with a control input.

FIG. 3 is an illustration of a multi-ID tag with a control input.

FIG. 4 is an illustration of a multi-ID tag with a control input.

FIG. 5 is an illustration of a multi-ID tag with a control input.

FIG. 6 is an illustration of a multi-ID tag with a control input.

FIG. 7 is an illustration of a multi-ID tag with a control input.

FIG. 8 is an illustration of a multi-ID tag with a control input and a receiver with a switch element.

FIG. 9 is an illustration of multi-ID tag(s) with a control input and a receiver with a switch element.

FIG. 10 is an illustration of multi-ID tag(s) with a control input and a receiver with a switch element.

FIG. 11 is an illustration of multi-ID tag(s) with a control input and a transceiver with a switch element.

### DETAILED DESCRIPTION OF THE PRESENTLY PREFERRED EMBODIMENTS

What is needed in the art is an RFID tag that provides for a control input for selecting an appropriate ID, or list of ID's, for transmission on the energizing of the RFID tag by the energy transmission element. The invention described below meets this need.

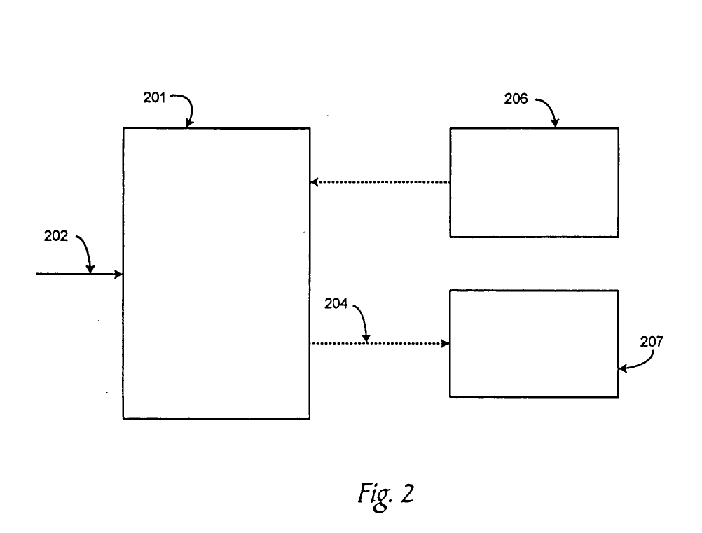

FIG. 2 describes a multi-ID tag 201. Control input 202 determines which of a set of selectable ID's will be transmitted on the energizing of multi-ID tag 201 by the energy transmission element 206, or in response to control input 202. Control input 202 could take the form of a manually-operated mechanical switch or an electrical signal. The transmitted ID signal 204 is received by the ID receiver 207.

Such a multi-ID tag can extend RFID technology into new application areas. As a non-limiting example, a multi-ID RFID tag can be used as a wireless light switch, wherein one unique ID corresponds to the light being set to “ON”, and another unique ID corresponds to the light being set to “OFF”. Combination of ID's for more than two states can be employed. A list of 3 IDs results in 6 illumination levels, in addition to ON and OFF. The control input can either be a manual switch, or an electrical input, as from a light sensor. In addition to use as a wireless light switch or a wireless light illumination control, a multi-ID tag can be used in other applications, such as in the remote control of home appliances, including, but not limited to, a stereo, television, coffee maker, computer, and garage door.

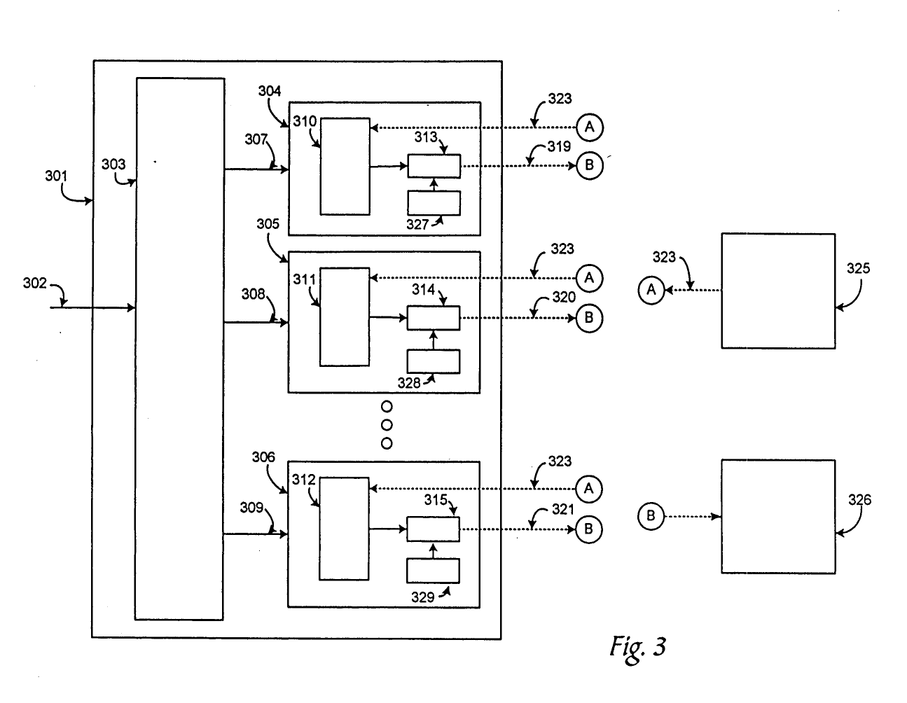

In FIG. 3, multi-ID tag 301 receives a control input 302. This could be either a mechanical or electrical input. Contained in multi-ID tag 301 are multiple passive RFID tags 304, 305, 306. (In this and other embodiments, one or more of the multi-ID RFID tags can be implemented on a single printed circuit board.) Each RFID tag 304, 305, 306 contains an energy collection element 310, 311, 312, an ID transmitter 313, 314 315, and a unique ID 327, 328, 329. Energy to power the ID transmitters 313, 314, 315 is provided by the energy collection elements 310, 311, 312, which receive energy from the energy transmission element 325 via wireless means 323. The multi-ID tag 301 contains a control mechanism 303. Based on the control input 302, the control mechanism 303 provides an enable/disable signal 307, 308, 309 to the RFID tags 304, 305, 306. If the enable/disable signal 307, 308, 309 is set to “enable,” the RF transmitter 310, 311, 312 will transmit unique ID 327, 328, 329 respectively. If the enable/disable signal 307, 308, 309 is set to “disable,” the RF transmitters 313, 314, 315 will not transmit unique IDs 327, 328, 329 respectively. The unique IDs 327, 328, 329 are transmitted via wireless means 319, 320, 321 and are received by the ID receiver 326.

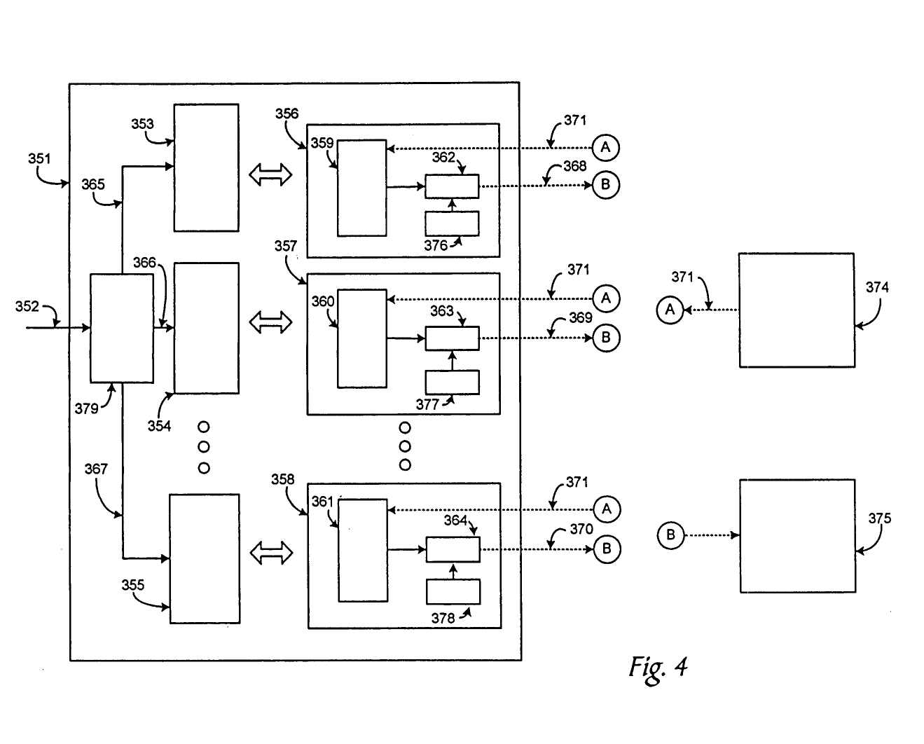

In FIG. 4, multi-ID tag 351 receives a control input 352. Contained in multi-ID tag 351 are multiple RFID tags 356, 357, 358. Each RFID tag 356, 357, 358 contains an energy collection element 359, 360, 361, an ID transmitter 362, 363, 364, and a unique ID 376, 377, 378. Energy to power the ID transmitters 362, 363, 364 is provided by the energy collection elements 359, 360, 361, which receive energy from the energy transmission element 374 via wireless means 371. The multi-ID tag 351 contains a control mechanism 379. Based on the control input 352, the control mechanism 379 provides enable/disable signals 365, 366, 367 to the RF shields 353, 354, 355. If the enable/disable signal 365, 366, 367 is set to “enable,” no shield is deployed over energy collection element 359, 360, 361. If the enable/disable signal 365, 366, 367 is set to “disable,” an RF shield 353, 354, 355 is deployed over energy collection element 359, 360, 361, thus preventing the ID transmitters 362, 363, 364 from transmitting the unique IDs 376, 377, 378. The unique IDs 376, 377, 378 are transmitted via wireless means 368, 369, 370 and are received by the ID receiver 375.

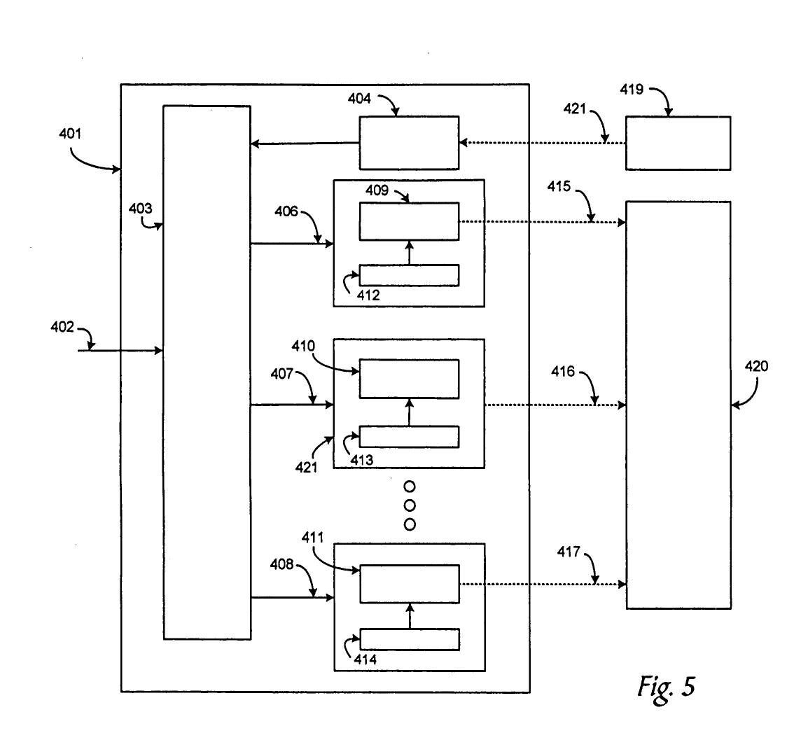

In FIG. 5, multi-ID tag 401 receives a control input 402. Contained in multi-ID tag 401 are multiple ID transmitters 409, 410, 411 and multiple unique IDs 412, 413, 414. Energy to power the ID transmitters 409, 410, 411 is provided by a common energy collection element 404, which receives energy from the energy transmission element 419 via wireless means 421. The multi-ID tag 401 contains a control mechanism 403. Based on the control input 402, the control mechanism 403 provides an enable/disable signal 406, 407, 408 to the ID transmitters 409, 410, 411. If the enable/disable signal 406, 407, 408 is set to “enable,” the ID transmitter 409, 410, 411 will transmit unique ID 412, 413, 414. If the enable/disable signal 406, 407, 408 is set to “disable,” the RF transmitters 409, 410, 411 will not transmit unique IDs 412, 413, 414. The unique IDs 412, 413, 414 are transmitted via wireless means 415, 416, 417 and are received by the ID receiver 420.

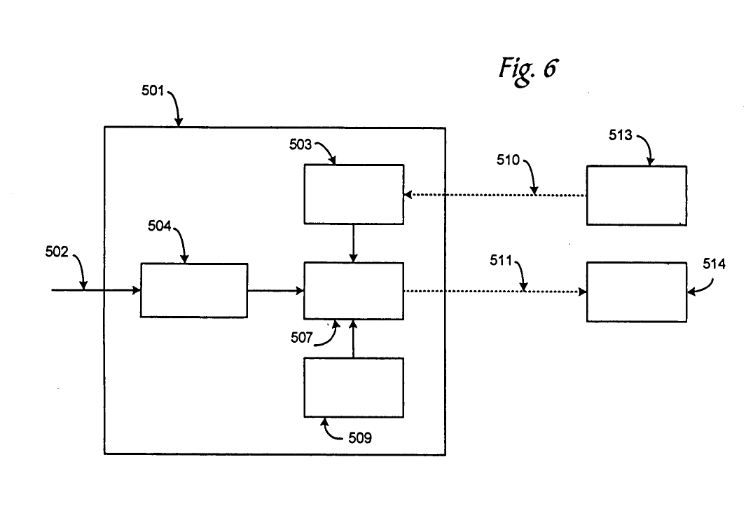

FIG. 6 features a passive multi-ID tag 501 operating in conjunction with energy transmission element 513 and ID receiver 514. Control input 502 determines which of a set of selectable ID's will be transmitted on the energizing of passive multi-ID tag 501 by the energy transmission element 513, or at the initiation of control mechanism 504. The control mechanism 504 configures the ID transmitter 507 to transmit the ID or ID's corresponding to the selection implicit in the control input 502. The control mechanism 504 may also initiate transmission of the selected ID or ID's, if energy is available from an earlier energizing of passive multi-ID tag 501 by the energy transmission element 513. Control input 502 could take the form of a manually-operated mechanical switch or an electrical signal. The set of selectable ID's is recorded in ID list 509. Energy for the passive multi-ID tag 501 is provided by the energy collection element 503, which receives energy from the energy transmission element 513 via wireless means 510 and either transfers it to ID transmitter 507, or stores it for use by ID transmitter 507 as directed by control mechanism 504. The ID signal 511 is transmitted by the ID transmitter 507 via wireless means 531 to the ID receiver 514.

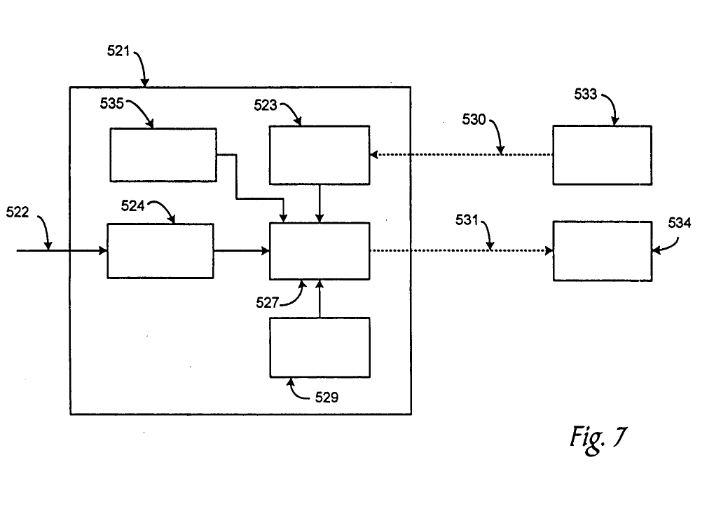

FIG. 7 features a semi-active multi-ID tag 521 operating in conjunction with energy transmission element 533 and ID receiver 534. Control input 522 determines which of a set of selectable ID's will be transmitted on the energizing of semi-active multi-ID tag 521 by the energy transmission element 533, or at the initiation of control mechanism 524. The control mechanism 524 configures the ID transmitter 527 to transmit the ID or ID's corresponding to the selection implicit in the control input 522. The control mechanism 524 may also initiate transmission of the selected ID or ID's. Control input 522 could take the form of a manually-operated mechanical switch or an electrical signal. The set of selectable ID's is recorded in ID list 529. Energy from the energy transmission element 533 is sent via wireless transmission means 530 to energy collection element 523 where it may be applied to initiate transmission of the selected ID or ID's by ID transmitter 527 via wireless means 531 to ID receiver 534 utilizing energy stored in battery 535.

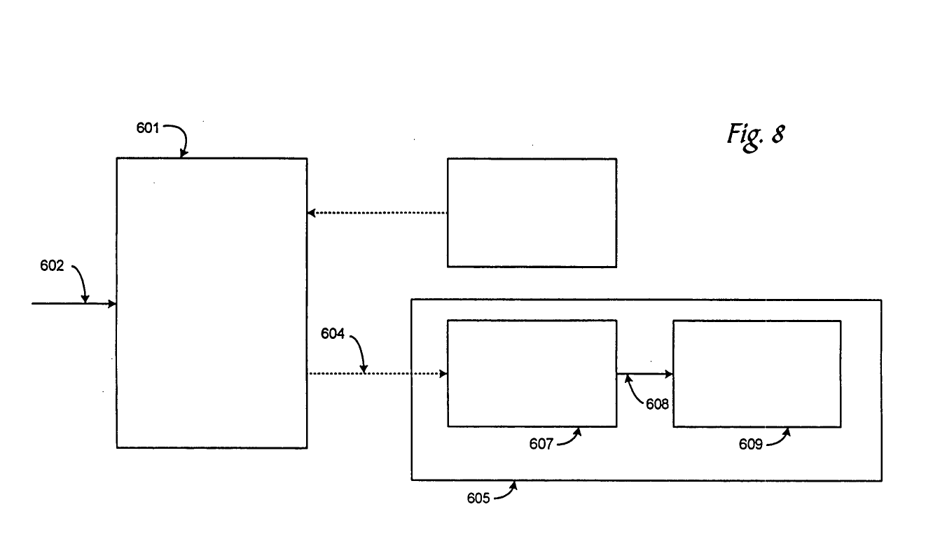

FIG. 8 describes the application of a multi-ID tag 601 to implement wireless switching of an electrical circuit via actuator 605, comprising intelligent ID receiver 607 and switch element 609. Control input 602 is used to select the desired position of the switch element 609, which may be ON or OFF or something in between. Based on the control input 602, the multi-ID tag 601 transmits, via wireless means, the ID or ID's corresponding to the desired position of the switch, as ID signal 604, to intelligent ID receiver 607. The ID signal 604 is received by intelligent ID receiver 607 and decoded to generate control signal 608, which controls the position of switch element 609.

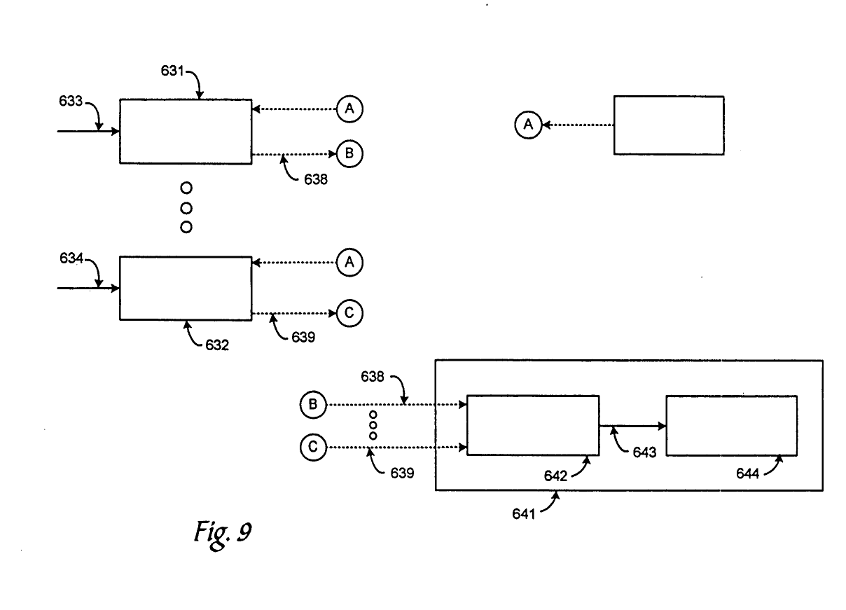

FIG. 9 describes the application of multiple multi-ID tags 631, 632 to implement wireless switching of an electrical circuit via actuator 641, comprising intelligent ID receiver 642 and switch element 644. Control inputs 633, 634 are used to select the desired position of the switch element 644, which may be ON or OFF or something in between. Based on the control input 633, 634, the multi-ID tag 631, 632 transmits, via wireless means, the ID or ID's corresponding to the desired position of the switch as ID signal 638, 639 to intelligent ID receiver 642. The ID signal 638, 639 is received by intelligent ID receiver 642 and decoded to generate control signal 643, which controls the position of switch element 644.

By way of illustration, suppose that the electrical circuit takes the form of an interconnection of lights in series, and multiple multi-ID tags are used to switch the lights ON and OFF from different locations. The intelligent ID receiver need only detect changes in the ID's transmitted by the several tags.

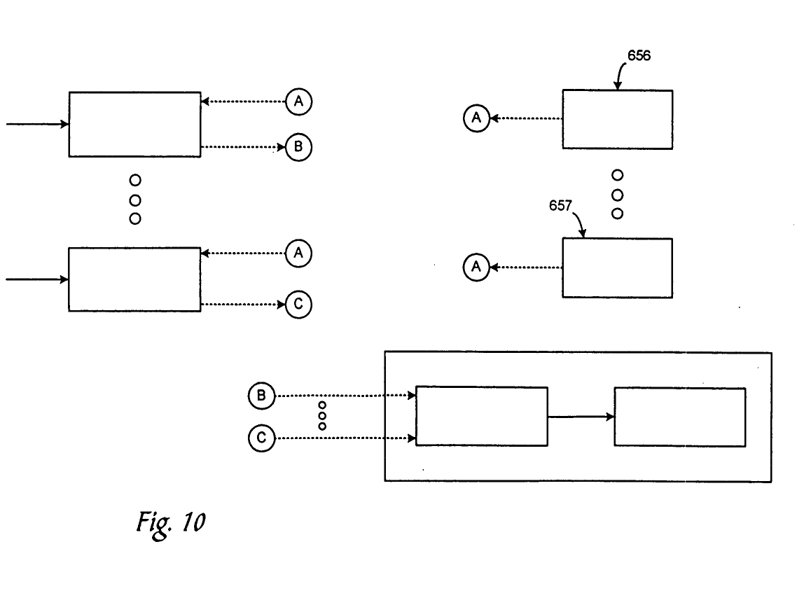

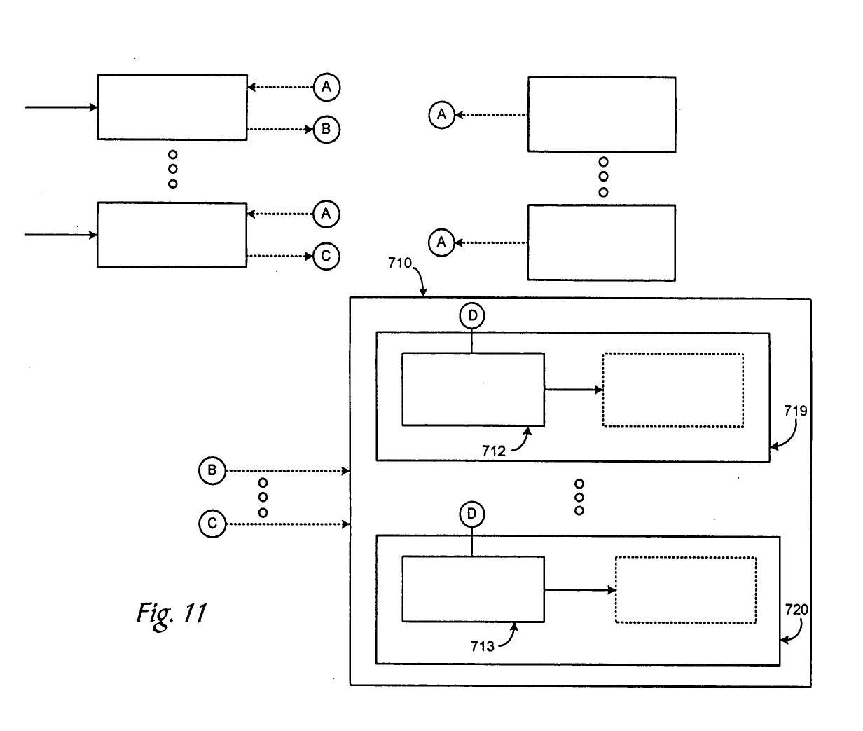

If multi-ID tags are distributed at some distance from the actuator, it may be useful to deploy multiple energy transmission elements 656, 657 (see FIG. 10). Under these conditions, it may further be useful to deploy a network 710 of intercommunicating actuators 719, 720, each with an intercommunicating ID transceiver 712, 713 (see FIG. 11), to insure that transmissions from remotely located tags are received reliably.

Lastly, “Wireless Electronic Device with a Kinetic-Energy-to-Electrical-Energy Converter,” U.S. patent application Ser. No. ______ (attorney docket no. 13111/3, filed herewith), which is assigned to the assignee of the present patent application and is hereby incorporated by reference, describes a technique for converting kinetic energy generated when a user moves a movable user interface element of a wireless electronic device to electrical energy. Such electrical energy can be used to provide power to the wireless electronic device. Any of the embodiments presented in that application can be used with any of the embodiments presented in this application.

It is intended that the foregoing detailed description be understood as an illustration of selected forms that the invention can take and not as a definition of the invention. It is only the following claims, including all equivalents, that are intended to define the scope of this invention.

What is claimed is:

1. A radio frequency identification (RFID) device comprising:
a radio frequency (RF) transmitter;
a plurality of identifiers;
an input operative to receive a selection indicative of a set of the plurality of identifiers; and
a control mechanism operative to cause the RF transmitter to transmit the set of identifiers indicated by the selection.

2. The RFID device of claim 1, wherein the RFID device comprises a single RFID tag.

3. The RFID device of claim 1, wherein the RFID device comprises a plurality of RFID tags, each RFID tag storing a respective one of the plurality of identifiers.

4. The RFID device of claim 1, wherein the set of identifiers comprises a single identifier.

5. The RFID device of claim 1, wherein the set of identifiers comprises more than one identifier.

6. The RFID device of claim 1 further comprising an energy collection element, and wherein the RF transmitter transmits the set of identifiers in response to energy received by the energy collection element.

7. The RFID device of claim 1, wherein the RF transmitter transmits the set of identifiers in response to a received input.

8. The RFID device of claim 1, wherein the input is selected from the group consisting of a mechanical input and an electrical input.

9. The RFID device of claim 1 further comprising a battery in communication with the RF transmitter.

10. The RFID device of claim 1, wherein the RFID device is used in a wireless light switch.

11. The RFID device of claim 1, wherein the RFID device is used in an application selected from the group consisting of a wireless light illumination control, remote control of a home appliance, remote control of a stereo, remote control of a television, remote control of a coffee maker, remote control of a computer, and remote control of a garage door.

12. A radio frequency identification (RFID) device comprising:
a plurality of RFID tags storing a plurality of identifiers, wherein each of the plurality of RFID tags comprises a respective radio frequency (RF) transmitter and stores a respective one of the plurality of identifiers;
an input operative to receive a selection indicative of a set of the plurality of identifiers; and
a control mechanism operative to cause the RF transmitter(s) of the RFID tag(s) storing the set of identifiers to transmit the set of identifiers.

13. The RFID device of claim 12, wherein the plurality of RFID tags are implemented on a printed circuit board.

14. The RFID device of claim 12, wherein the control mechanism is operative to cause the RF transmitter(s) of the RFID tag(s) to transmit the set of identifiers by providing signals to enable the RF transmitter(s) of the RFID tag(s).

15. The RFID device of claim 12, wherein each of the plurality of RFID tags comprises a respective energy collection element, wherein the RFID device further comprises a plurality of RF shields for the plurality of energy collection elements, and wherein the control mechanism is operative to cause the RF transmitter(s) of the RFID tag(s) to transmit the set of identifiers by providing signals to disable the RF shield(s) for each of the RFID tag(s) storing the set of identifiers.

16. The RFID device of claim 12 further comprising a common energy collection element shared by the plurality of RFID tags.

17. The RFID device of claim 12, wherein the set of identifiers comprises a single identifier.

18. The RFID device of claim 12, wherein the set of identifiers comprises more than one identifier.

19. The RFID device of claim 12, wherein each RFID tag further comprises an energy collection element, and wherein an RF transmitter of an RFID tag transmits the identifier of the RFID tag in response to energy received by the energy collection element.

20. The RFID device of claim 12, wherein an RF transmitter of an RFID tag transmits the identifier of the RFID tag in response to a received input.

21. The RFID device of claim 12, wherein the input is selected from the group consisting of a mechanical input and an electrical input.

22. The RFID device of claim 12, wherein the RFID device is used in a wireless light switch.

23. The RFID device of claim 12, wherein the RFID device is used in an application selected from the group consisting of a wireless light illumination control, remote control of a home appliance, remote control of a stereo, remote control of a television, remote control of a coffee maker, remote control of a computer, and remote control of a garage door.

24. A radio frequency identification (RFID) system comprising:
an RFID device comprising:
a radio frequency (RF) transmitter;
a plurality of identifiers;
an input operative to receive a selection indicative of a set of the plurality of identifiers; and
a control mechanism operative to cause the RF transmitter to transmit the set of identifiers indicated by the selection; and
an actuator comprising:
a switch; and
a receiver operative to receive the set of identifiers transmitted by the RF transmitter and control a position of the switch based on the set of identifiers.

25. The RFID system of claim 24, wherein the RFID device comprises a single RFID tag.

26. The RFID system of claim 24, wherein the RFID device comprises a plurality of RFID tags, each RFID tag storing a respective one of the plurality of identifiers.

27. The RFID system of claim 24, wherein the RFID device further comprises at least one energy collection element, and wherein the RFID system comprises a plurality of energy transmission elements.

28. The RFID system of claim 24 further comprising at least one additional actuator, wherein the first-mentioned actuator and the at least one additional actuator comprise intercommunicating transceivers.

29. The RFID system of claim 24, wherein the actuator controls a flow of current in an electrical circuit.

30. The RFID system of claim 24, wherein the actuator controls a light switch.

31. The RFID system of claim 24, wherein the actuator controls a device selected from the group consisting of a light illumination control, a home appliance, a stereo, a television, a coffee maker, a computer, and a garage door.
